(19) United States
(12) Patent Application Publication
(10) Pub. No.: US 2018/0232331 A1
(43) Pub. Date: Aug. 16, 2018

(54) SERVER SYSTEM, FABRIC CARD AND METHOD FOR ALLOCATING IP ADDRESS

(71) Applicant: ACCTON TECHNOLOGY CORPORATION, HSINCHU (TW)

(72) Inventor: Wei-Hsiang HUANG, HSINCHU (TW)

(21) Appl. No.: 15/638,355

(22) Filed: Jun. 29, 2017

(30) Foreign Application Priority Data
Feb. 16, 2017 (TW) 106105133

(51) Int. Cl. G06F 13/40; H04L 29/12; G06F 15/173

(52) U.S. Cl. CPC G06F 13/404; H04L 61/2076; G06F 15/173; G06F 15/17331; G06F 13/4022

(57) ABSTRACT

Multiple slots are disposed on a chassis, and a fabric card is disposed in one of the slots. The fabric card includes following units. A first baseboard management controller (BMC) includes multiple pins. A first processor is coupled to the first BMC and obtains a first BMC identification (ID) of the first BMC by at least one pin of the first BMC. A second BMC also includes multiple pins. A second processor is coupled to the second BMC and obtains a second BMC ID of the second BMC by at least one pin of the second BMC. The first BMC ID is different from the second BMC ID.

### RELATED APPLICATIONS

This application claims priority to Taiwan Application Serial Number 106105133 filed Feb. 16, 2017, which is herein incorporated by reference.

### BACKGROUND

### Field of Invention

The present invention relates to a server system. More particularly, the present invention relates to the server system capable of obtaining a baseboard management controller (BMC) identification (ID) efficiently.

### Description of Related Art

A blade server is a modularized server computer in which unnecessary component are removed to save space and some other functional components (e.g. processor, BMC, memory) still exist as a computer. In general, the blade server is disposed in a slot of a chassis containing components such as power supply. FIG. 1 is a schematic diagram of the blade server in accordance with prior art. Referring to FIG. 1, the blade server includes a processor 110, a BMC 120 and a nonvolatile memory 130. The BMC 120 may be connected to other hardware such as fans. For the sake of simplification, not all components of the blade server are shown in FIG. 1. In the conventional technology, the processor 110 reads the identification (ID) of the BMC 120 from the nonvolatile memory 130. In other words, the ID has to be previously burned into the nonvolatile memory 130. If a program needs to access the ID of the BMC 120 but the ID is not burned into the nonvolatile memory 130 yet, then the program cannot be executed appropriately.

### SUMMARY

Embodiments of the invention provide a server system including a chassis. Multiple slots are disposed on the chassis, and a fabric card is disposed in one of the slots. The fabric card includes following units. A first baseboard management controller (BMC) includes multiple pins. A first processor is connected to the first BMC and obtains a first BMC identification (ID) of the first BMC through at least one of the pins of the first BMC. A second BMC includes multiple pins. A second processor is connected to the second BMC and obtains a second BMC ID of the second BMC through at least one of the pins of the second BMC. The first BMC ID is different from the second BMC ID.

In some embodiments, the first processor further obtains a first slot ID through at least one of the pins of the first BMC. The second processor further obtains a second slot ID through at least one of the pins of the second BMC. The first slot ID is identical to the second slot ID.

In some embodiments, the first processor calculates a priority ID according to the first BMC ID and the first slot ID and obtains an internet protocol (IP) address according to the priority ID.

In some embodiments, the first processor compares the priority ID with multiple predetermined priority ID in a lookup table to obtain the IP address recorded in the lookup table.

In some embodiments, the first processor obtains the first BMC ID through a first pin and a second pin of the pins of the first BMC, and the first pin and the second pin are general-purpose input/output (GPIO) pins.

In some embodiments, the first pin or the second pin is coupled to a pull-up resistor or a pull-down resistor.

From another aspect, embodiments of the invention provide a fabric card including following units. A first baseboard management controller (BMC) includes multiple pins. A first processor connected to the first BMC and obtains a first BMC identification (ID) of the first BMC through at least one of the pins of the first BMC. A second BMC includes multiple pins. A second processor is connected to the second BMC and obtains a second BMC ID of the second BMC through at least one of the pins of the second BMC. The first BMC ID is different from the second BMC ID.

From another aspect, embodiments of the invention provide a method for a blade server, in which the blade server includes a baseboard management controller (BMC) and a processor. The method includes: obtaining, by the processor, a slot identification (ID) of a slot where the blade server locates and a BMC ID of the BMC through at least one pin of the BMC; calculating a priority ID according to the BMC ID and the slot ID; and obtaining an internet protocol (IP) address of a network interface of the processor and the BMC according to the priority ID.

As a result, there is no need to previously burn the BMC ID into the nonvolatile memory.

### BRIEF DESCRIPTION OF THE DRAWINGS

The invention can be more fully understood by reading the following detailed description of the embodiment, with reference made to the accompanying drawings as follows.

FIG. 1 is a schematic diagram of the blade server in accordance with prior art.

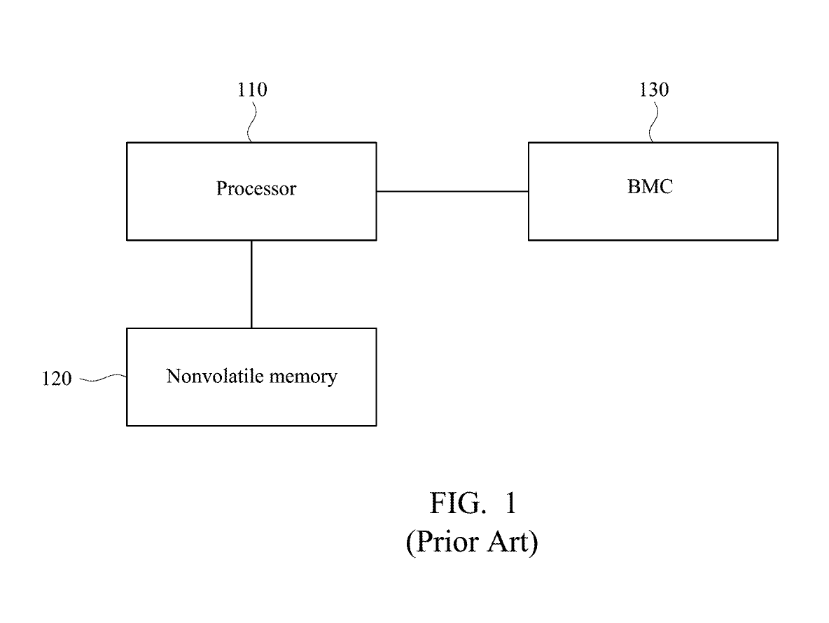

FIG. 2 is a top view of the back side of a server system in accordance with an embodiment.

FIG. 3 is a block diagram illustrating a line card in accordance with an embodiment.

FIG. 4 is a block diagram illustrating a fabric card in accordance with an embodiment.

FIG. 5 is a schematic diagram illustrating the pins on the BMC in accordance with an embodiment.

FIG. 6 is a flowchart of a diagnostic tool in accordance with an embodiment.

### DETAILED DESCRIPTION

Specific embodiments of the present invention are further described in detail below with reference to the accompanying drawings, however, the embodiments described are not intended to limit the present invention and it is not intended for the description of operation to limit the order of implementation. Moreover, any device with equivalent functions that is produced from a structure formed by a recombination of elements shall fall within the scope of the present invention. Additionally, the drawings are only illustrative and are not drawn to actual size.

The using of “first”, “second”, “third”, etc. in the specification should be understood for identifying units or data described by the same terminology but are not referred to particular order or sequence. In addition, the term “couple” used in the specification should be understood for electrically connecting two units directly or indirectly. In other words, when “a first object is coupled to a second object” is written in the specification, it means another object may be disposed between the first object and the second object.

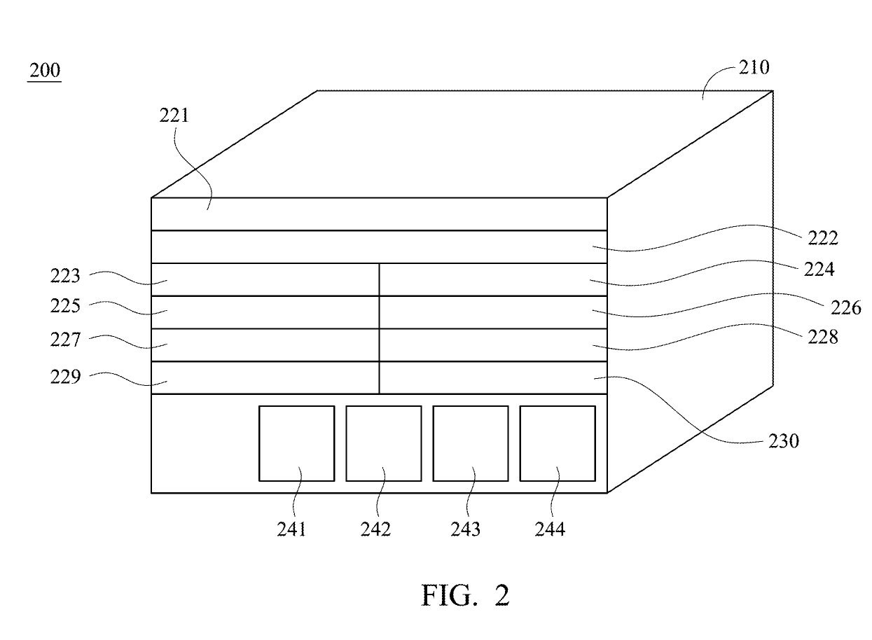

FIG. 2 is a top view of the back side of a server system in accordance with an embodiment. Referring to FIG. 2, a server system 200 includes a chassis 210. Ten slots 221-230 and four power supplies 241-244 are disposed in the chassis 210. However, the server system in FIG. 2 is just an example. The invention does not limit how many slots and power supplies are disposed in the server system and not limit the locations of the slots and the appearance, the shape, and the size of the chassis.

In some applications, functions of the blade server are further modularized into a fabric card for management and a line card for transferring packages. In general, the fabric card does not have front ports, and the line card does not have a management interface. In the embodiment of FIG. 2, the slots 221 and 222 are configured for disposing the fabric card, and the slots 223-230 are configured for disposing the line card. Each slot 221-230 has a slot ID.

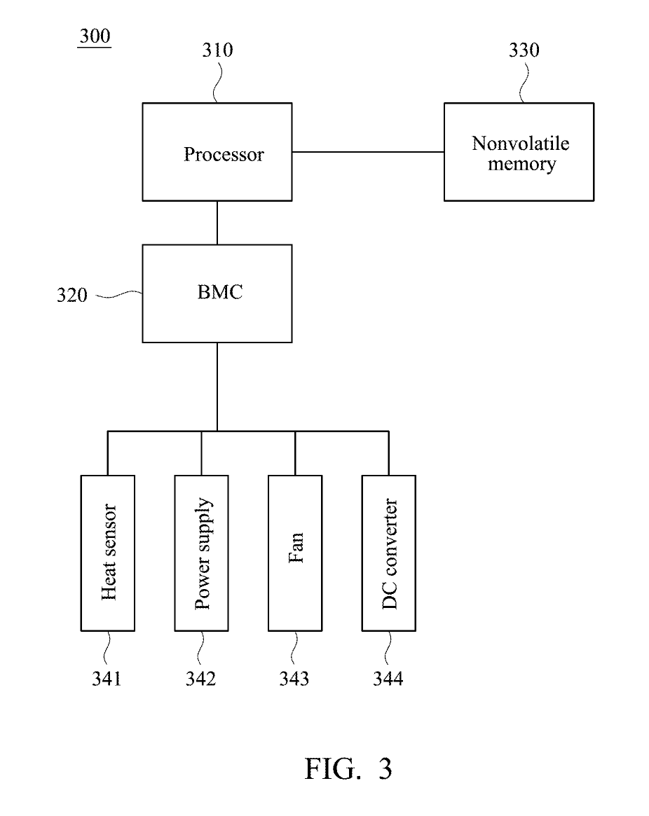

FIG. 3 is a block diagram illustrating a line card in accordance with an embodiment. Referring to FIG. 3, a line card 300 includes a processor 310, a Baseboard Management Controller 320 (hereinafter, BMC 320), and a nonvolatile memory 330. The processor 310 is coupled to the nonvolatile memory 330 and the BMC 320. The BMC 320 is further coupled to other hardware components such as a heat sensor 341, a power supply 342, a fan 343, and a DC converter 344. The processor 310 is, for example, a central processing unit. The nonvolatile memory 330 is, for example, Electrically-Erasable Programmable Read-Only Memory (EEPROM).

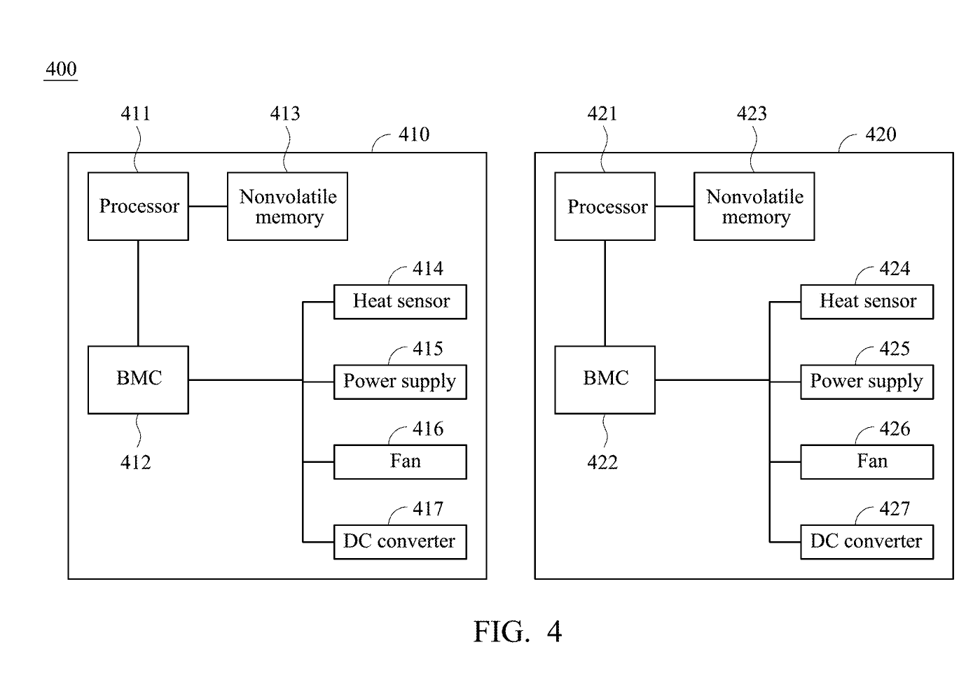

FIG. 4 is a block diagram illustrating a fabric card in accordance with an embodiment. Referring to FIG. 4, in the embodiment, a fabric card 400 is formed by integrating two line cards 410 and 420. In detail, the line card 410 includes a processor 411, a Baseboard Management Controller 412 (hereinafter, BMC 412), a nonvolatile memory 413, a heat sensor 414, a power supply 415, a fan 416, and a DC converter 417; the line card 420 includes a processor 421, a Baseboard Management Controller 412 (hereinafter, BMC 422), a nonvolatile memory 423, a heat sensor 424, a power supply 425, a fan 426, and a DC converter 427. The processors 411 and 421 are, for example, central processing units, and an independent operating system is performed on each of the processors 411 and 421. The nonvolatile memory 413 and 423 are, for example, EEPROM. The line card 410 is coupled to the line card 420 by, for example, a switch. In the embodiment of FIG. 4, the line card 410 and the line card 420 have respective hardware components such as heat sensor, power supply, fan, and DC converter. However, in other embodiments, one or more of the hardware components may be shared by the line card 410 and the line card 420, which is not limited in the invention.

Each line card requires an internet protocol (IP) address, and the two line cards in the fabric card require respective IP addresses. In some applications, the IP address may be decided according to the physical location in which the line card/fabric card is resided in one slot of the chassis. The physical location may be represented with a slot ID. One slot ID is enough for the line card because it requires only one IP address. However, one slot ID is not enough to decide two IP address for the fabric card because the two line cards in the fabric card share the same slot ID. In this case, BMC ID is further required. For example, the slot ID is combined with the BMC ID so that the two line cards in the same fabric card have different combinations of the slot ID and the BMC ID, and thus the combinations of the slot ID and the BMC ID may be configured to decide two IP addresses for the fabric card. Referring to FIG. 4, in prior art, an engineer has to manually burn the ID of the BMC 412 into the nonvolatile memory 413 and burn the ID of the BMC 422 into the nonvolatile memory 423, and then the processors 411 and 421 are able to access the corresponding BMC IDs. However, in the embodiment, the BMC ID is obtained according to pins of the BMCs 412 and 422, and therefore there is no need to manually burn the ID into the nonvolatile memory 413 and 423.

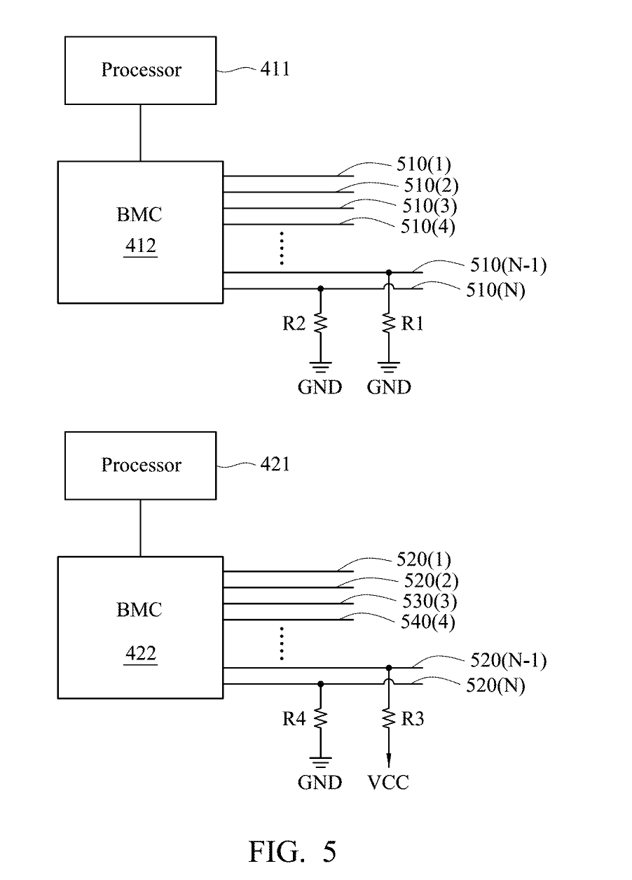

In detail, referring to FIG. 5, the BMC 412 has pins 510(1)-510(N), and the BMC 422 has pins 520(1)-520(N). N is a positive integer, but the value of the positive integer N is not limited in the invention. In some embodiments, the processor 411 (421) may send one or more commands to the BMC 412 (422) for reading the voltage level on a particular pin. The processor 411 would obtain the BMC ID (also referred to first BMC ID) of the BMC 412 through the voltage level on at least one of the pins 510(1)-510(N). On the other hand, the processor 421 would obtain the BMC ID (also referred to second BMC ID) of the BMC 422 through the voltage level on at least one of the pins 520(1)-520(N). In particular, the first BMC ID is different from the second BMC ID. For example, the pins 510(N-1) and 510(N) are General-Purpose Input/Output (GPIO) pins. The pin 510(N-1) is coupled to a ground GND through a pull-down resistor R1, and the pin 510(N) is coupled to the ground GND through a pull-down resistor R2. In the embodiment, the ground GND represents logical “0”, and therefore the ID of the BMC 412 is “00”. On the other hand, the pins 520(N-1) and 520(N) are also GPIO pins, the pin 520(N-1) is coupled to a system voltage VCC through a pull-up resistor R3, and the pin 520(N) is coupled to the ground GND through a pull-down resistor R4. Therefore, the ID of the BMC 422 is “01”.

In the embodiment, each BMC ID is determined by two pins because one fabric card may contain more than two line cards. However, the invention does not limit how many pins are used to determine one BMC ID. In other embodiments, one BMC ID may be determined by 1, 3, 4 or any number of pins. In addition, the ground GND represents logical “0” in the embodiment, but the ground GND may represent logical “1” in other embodiments. In the embodiment, the pins 510(N-1), 510(N), 520(N-1), and 520(N) are GPIO pins, but in other embodiment, the BMCs 412 and 422 may be coupled to one or more extending chips containing pins for the situation that the number of the pins on the BMCs 412 and 422 are not enough. One or more of the pins 510(N-1), 510(N), 520(N-1) and 520(N) may be the pins on the extending chip, and the invention does not limit whether the pins 510(N-1), 510(N), 520(N-1) and 520(N) are directly disposed on the BMCs 412 and 422.

On the other hand, some of the pins on the BMC may be used to determine the slot ID. For example, the pins 510(1)-510(4) are also coupled to pull-up resistors or pull-down resistors for determining a slot ID (also referred to a first slot ID). The pins 520(1)-520(4) are also coupled to pull-up resistors or pull-down resistors for determining a slot ID (also referred to a second slot ID). Note that the first slot ID is identical to the second slot ID because the BMCs 412 and 422 are disposed in the same fabric card. In the embodiments, four pins are used to determine one slot ID, but any other number of pins may be used, which is not limited in the invention.

A physical location of the processor or BMC in the server system may be determined by combining the slot ID with the BMC ID. The physical location may be used to decide an IP address. For example, if SLOT_ID denotes the slot ID and BMC_ID denotes the BMC ID, then the processors 411 and 421 can calculate a priority ID PRIORITY_ID according to the following equation (1).

PRIORITY_ID=(SLOT_ID<<n)|BMC_ID (1)

n is a positive integer representing the bit number of BMC_ID. The processors 411 and 421 can obtain an IP address according to the respective priority ID. It is worth mentioning that the priority ID calculated by the processor 411 would be different from priority ID calculated by the processor 421, and therefore the two IP addresses obtained based on the priority IDs are different from the each other.

In some embodiments, the processors 411 and 421 may compare the calculated priority ID with information in a lookup table to obtain the IP address. For example, multiple predetermined priority IDs and IP addresses are recorded in the lookup table, and each predetermined priority ID corresponds to one IP address in the lookup table. The processors 411 and 421 compare the calculated priority ID with the predetermined priority IDs in the lookup table and obtains the corresponding IP address after the same priority ID is found in the lookup table. One of the reasons of using the lookup table is that the priority IDs corresponding to the slots of the server system may not be continuous while the allocated IP addresses may be continuous. Therefore, the discontinuous priority IDs are mapped to the continuous IP addresses trough the lookup table. The embodiment of the lookup table is just an example, and the correspondence and the content of the lookup table are not limited in the invention. In other embodiments, the processors 411 and 421 may perform logical operations on the priority ID to obtain the IP address, which is not limited in the invention. In addition, the calculation of the priority ID is just an example, and any other logical operation may be performed on the slot ID SLOT_ID and the BMC ID BMC_ID to obtain the priority ID.

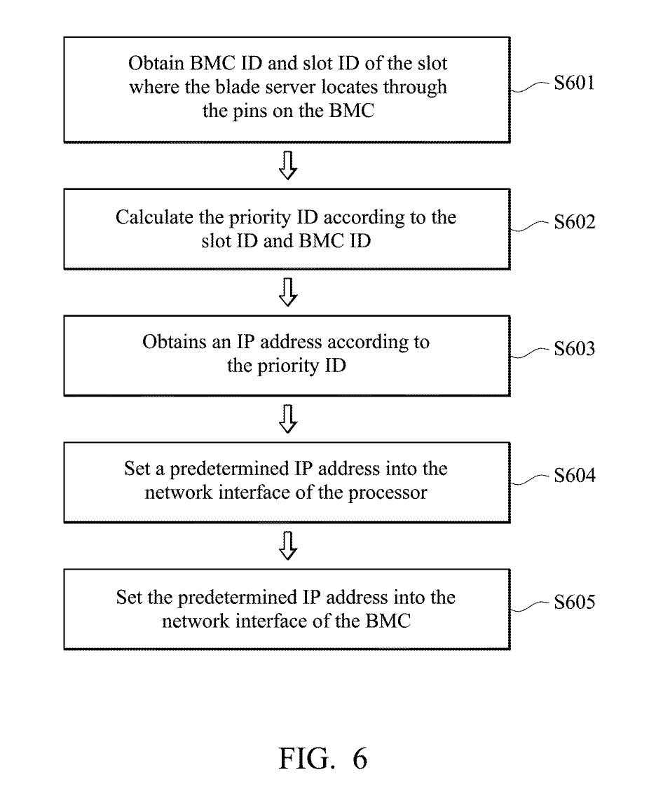

Referring to FIG. 4, because the BMC ID is obtained through the pins of the BMCs 412 and 422, there is no need to previously burn the ID into the nonvolatile memory 413 and 423. Moreover, the approach of obtaining the BMC ID through the pins may be applied to the line card, which is not limited in the invention. In general, more than one blade servers are disposed in the server system, and each blade server at least includes a processor and a BMC. If the BMC ID is obtained through the pins of the BMC, it is in the spirit of the invention. After the BMC ID is obtained, some programs may be performed efficiently. For example, FIG. 6 is a flowchart of a diagnostic tool in accordance with an embodiment. The method of FIG. 6 may be applied to the aforementioned blade server which may be line card or fabric card. Referring to FIG. 6, in step S601, the processor of the blade server obtains BMC ID and slot ID of the slot where the blade server locates through the pins on the BMC. In step S602, the processor calculates the priority ID according to the slot ID and BMC ID. In step S603, the processor obtains an IP address according to the priority ID. In some embodiments, the blade server further includes a memory, the processor loads the lookup table into the memory, and the processor compares the priority ID calculated in the step S603 with information in the lookup table to obtain the IP address. In step S604, the processor sets a predetermined IP address into the network interface of the processor. In step S605, the processor sets the predetermined IP address into the network interface of the BMC. However, the steps S601-S603 have been described in detail above, and person in the art should be able to understand the steps S604 and S605, and therefore the description will not be repeated. The diagnostic tool of FIG. 6 is just an example, and the invention does not limit which program would use the slot ID and the BMC ID. For example, in some embodiments, the steps S604 and S605 may be omitted or replaced with some other steps. Alternatively, the steps S601-S603 may be included in another program other than the diagnostic tool. In some embodiments, the steps S601-S603 may be performed independently or collectively as a method for allocating IP addresses or a method for determining the priority of the processor or the BMC.

Although the present invention has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A server system comprising a chassis, wherein a plurality of slots are disposed on the chassis, a fabric card is disposed in one of the slots, and the fabric card comprises:
a first baseboard management controller (BMC) comprising a plurality of pins;
a first processor connected to the first BMC and obtaining a first BMC identification (ID) of the first BMC through at least one of the pins of the first BMC;
a second BMC comprising a plurality of pins; and
a second processor connected to the second BMC and obtaining a second BMC ID of the second BMC through at least one of the pins of the second BMC,
wherein the first BMC ID is different from the second BMC ID.

2. The server system of claim 1, wherein the first processor further obtains a first slot ID through at least one of the pins of the first BMC,
wherein the second processor further obtains a second slot ID through at least one of the pins of the second BMC,
wherein the first slot ID is identical to the second slot ID.

3. The server system of claim 2, wherein the first processor calculates a priority ID according to the first BMC ID and the first slot ID and obtains an internet protocol (IP) address according to the priority ID.

4. The server system of claim 3, wherein the first processor compares the priority ID with a plurality of predetermined priority IDs in a lookup table to obtain the IP address recorded in the lookup table.

5. The server system of claim 1, wherein the first processor obtains the first BMC ID through a first pin and a second pin of the pins of the first BMC, and the first pin and the second pin are general-purpose input/output (GPIO) pins.

6. The server system of claim 5, wherein the first pin or the second pin is coupled to a pull-up resistor or a pull-down resistor.

7. A fabric card comprising:
a first baseboard management controller (BMC) comprising a plurality of pins;
a first processor connected to the first BMC and obtaining a first BMC identification (ID) of the first BMC through at least one of the pins of the first BMC;
a second BMC comprising a plurality of pins; and
a second processor connected to the second BMC and obtaining a second BMC ID of the second BMC through at least one of the pins of the second BMC,
wherein the first BMC ID is different from the second BMC ID.

8. The fabric card of claim 7, wherein the first processor further obtains a first slot ID through at least one of the pins of the first BMC,
wherein the second processor further obtains a second slot ID through at least one of the pins of the second BMC,
wherein the first slot ID is identical to the second slot ID.

9. The fabric card of claim 8, wherein the first processor calculates a priority ID according to the first BMC ID and the first slot ID and obtains an internet protocol (IP) address according to the priority ID.

10. The fabric card of claim 9, wherein the first processor compares the priority ID with a plurality of predetermined priority IDs in a lookup table to obtain the IP address recorded in the lookup table.

11. The fabric card of claim 7, wherein the first processor obtains the first BMC ID through a first pin and a second pin of the pins of the first BMC, and the first pin and the second pin are general-purpose input/output (GPIO) pins.

12. The fabric card of claim 11, wherein the first pin or the second pin is coupled to a pull-up resistor or a pull-down resistor.

13. A method for a blade server comprising a baseboard management controller (BMC) and a processor, wherein the method comprises:
obtaining, by the processor, a slot identification (ID) of a slot where the blade server locates and a BMC ID of the BMC through at least one pin of the BMC;
calculating a priority ID according to the BMC ID and the slot ID; and
obtaining an internet protocol (IP) address of a network interface of the processor and the BMC according to the priority ID.
